(19) United States
(12) Patent Application Publication
(10) Pub. No.: US 2009/0043624 A1
(43) Pub. Date: Feb. 12, 2009

(54) ELECTRONIC PROFILE CREATION

(75) Inventors: Brian Fioca, Seattle, WA (US); Anthony Wright, Seattle, WA (US)

Correspondence Address: BLACK LOWE & GRAHAM, PLLC, 701 FIFTH AVENUE, SUITE 4800, SEATTLE, WA, 98104, US

(73) Assignee: Jobster, Inc., Seattle, WA (US)

(21) Appl. No.: 12/099,031

(22) Filed: Apr. 7, 2008

Related U.S. Application Data
(63) Continuation of application No. 11/841,366, filed on Aug. 20, 2007.
Application No. 11/841,366 is a continuation of application No. 11/083,029, filed on Mar. 18, 2005.
Application No. 11/083,029 is a continuation of application No. 11/083,950, filed on Mar. 21, 2005.
Application No. 11/083,950 is a continuation of application No. 11/082,935, filed on Mar. 18, 2005.
Application No. 11/082,935 is a continuation of application No. 11/758,420, filed on Jun. 5, 2007.
(60) Provisional application No. 60/822,780, filed on Aug. 18, 2006.
(60) Provisional application No. 60/862,849, filed on Oct. 25, 2006.
(60) Provisional application No. 60/823,821, filed on Aug. 29, 2006.
(60) Provisional application No. 60/938,135, filed on May 15, 2007.

(51) Int. Cl. G06F 15/02

(52) U.S. Cl. 705/7

(57) ABSTRACT

A method is implementable in an electronic system coupled to an electronic device, which is, in turn, coupled to a display device. A web page displayable on the display device is served to the electronic device. The displayed web page includes a user interface, which, in turn, includes a selection field. A first set of selectable tags is displayed in the selection field. Each of the first-set tags corresponds to a respective vocational characteristic of a first set of vocational characteristics. At least one selection by a user of a tag is received. An employment profile of the user is generated using the at least one tag selection.

### PRIORITY CLAIM

The present application is a continuation of U.S. patent application Ser. No. 11/841,366 filed on Aug. 20, 2007 which claims priority from U.S. Provisional Application No. 60/822,780 filed Aug. 18, 2006, which is, along with commonly owned and co-pending U.S. patent application Ser. No. 60/862,849 filed Oct. 25, 2006 and U.S. Provisional Application No. 60/823,821 filed Aug. 29, 2006, which are, along with commonly owned and co-pending U.S. Provisional Application No. 60/820,583 filed Jul. 27, 2006; U.S. patent application Ser. No. 11/083,029 filed Mar. 18, 2005 and U.S. patent application Ser. No. 11/083,950 filed Mar. 18, 2005, and U.S. patent application Ser. No. 11/082,935 filed Mar. 18,2005 and U.S. Provisional Application Ser. No. 60/938,135 filed May 15, 2007 and U.S. patent application Ser. No. 11/758,420 filed Jun. 5, 2007 herein incorporated by reference.

### FIELD OF THE INVENTION

This invention relates generally to computer-implemented processes and, more specifically, to generation of electronic user profiles.

### BACKGROUND OF THE INVENTION

Methods and apparatus involving job searching and placement services are known in the art. Such methods and apparatus are offered, for example, on well known Internet Web sites.

The known methods and apparatus fail to provide a way for candidates to conveniently and concisely identify their professional strengths and or strong interests to better enable being quickly located by an employer with whom the candidate would be a good fit.

Other problems with the prior art not described above can also be overcome using the teachings of embodiments of the present invention, as would be readily apparent to one of ordinary skill in the art after reading this disclosure.

### SUMMARY OF THE INVENTION

In an embodiment of the invention, a method is implementable in an electronic system coupled to an electronic device, which is, in turn, coupled to a display device. A web page displayable on the display device is served to the electronic device. The displayed web page includes a user interface, which, in turn, includes a selection field. A first set of selectable tags is displayed in the selection field. Each of the first-set tags corresponds to a respective vocational characteristic of a first set of vocational characteristics. At least one selection by a user of a tag is received. An employment profile of the user is generated using the at least one tag selection.

### BRIEF DESCRIPTION OF THE DRAWINGS

Preferred and alternative examples of the present invention are described in detail below with reference to the following drawings:

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a first schematic view of a graphical user interface (GUI) according to an embodiment of the invention;

FIG. 4 is a second schematic view of the GUI according to an embodiment of the invention;

FIG. 5 is a third schematic view of the GUI according to an embodiment of the invention;

FIG. 6 is a fourth schematic view of the GUI according to an embodiment of the invention;

FIG. 7 is a flow diagram illustrating a first method according to an embodiment of the invention;

FIG. 8 is a flow diagram illustrating a second method according to an embodiment of the invention; and

FIG. 9 is a flow diagram illustrating a third method according to an embodiment of the invention.

### DETAILED DESCRIPTION OF THE PREFERRED EMBODIMENT

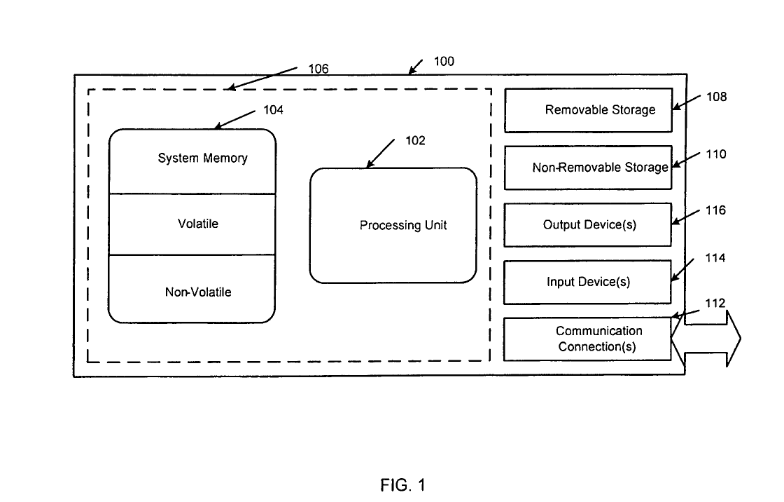

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of embodiments of the invention. Neither should the computing environment 100 be interpreted as having any dependency or requirement relating to anyone or combination of components illustrated in the exemplary operating environment 100.

Embodiments of the invention are operational with numerous other general-purpose or special-purpose computing-system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed-computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed-computing environment, program modules may be located in both local- and remote-computer storage media including memory storage devices.

With reference to FIG. 1, an exemplary system for implementing an embodiment of the invention includes a computing device, such as computing device 100. In its most basic configuration, computing device 100 typically includes at least one processing unit 102 and memory 104.

Depending on the exact configuration and type of computing device, memory 104 may be volatile (such as random-access memory (RAM)), non-volatile (such as read-only memory (ROM), flash memory, etc.) or some combination of the two. This most basic configuration is illustrated in FIG. I by dashed line 106.

Device 100 may have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 100 may also have input device(s) 114 such as keyboard, mouse, pen, voice-input device, touch-input device, etc. Output device(s) 116 such as a display, speakers, printer, etc. may also be included.

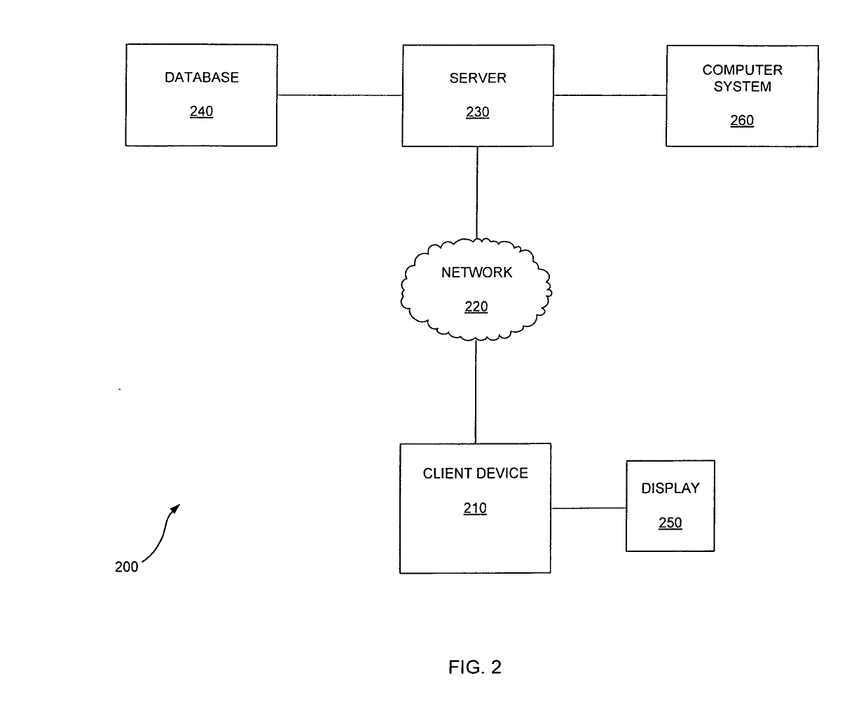

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers via one or more such communication media.

In an embodiment, each of the client device 210 and server 230 may include all or fewer than all of the features associated with the device 100 illustrated in and discussed with reference to FIG. 1. Client device 210 includes or is otherwise coupled to a computer screen or display 250. Client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

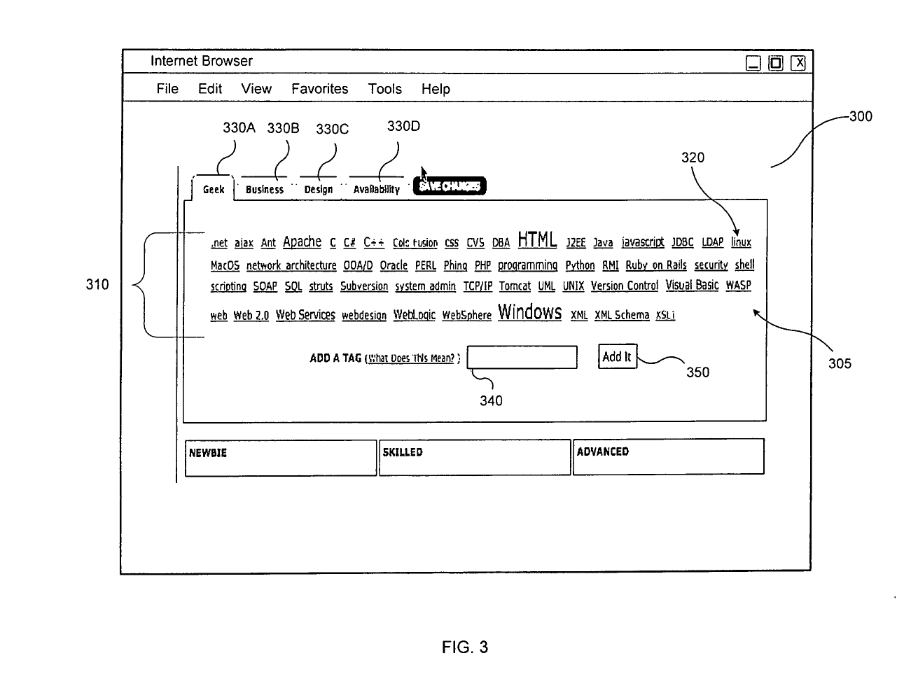

Still referring to FIG. 2, and in operation according to an embodiment of the invention, a user (not shown) of the client device 210 desiring to electronically prepare an employment profile uses a browser application running on the client device to access web content served by the server 230. Specifically, and referring to FIG. 3, by employing an appropriate uniform resource locator (URL) in a known manner, the user may request a web page 300 to be displayed on the display device 250. As is discussed in further detail below, the web page 300 provides a graphical user interface including a selection field 305 that allows the user to input object selections and/or data from which an employment profile may be prepared.

In an embodiment, and still referring to FIG. 3, the displayed web page 300 includes a set of selectable tags 310 in the selection field 305. Each of the tags 310 is descriptive of a vocational characteristic that may be used to at least partially describe a user. These vocational-characteristic qualities that the tags 310 describe may include, by way of non-limiting example, areas of specific vocational expertise, past employers, educational institutions attended, hobbies, availability to start a new job, and general ability. Moreover, each of the tags 310 may be displayed on the page 300 as an object that may be selected by a user via, for example, a conventional point-and-click device, such as a mouse. For example, in the process of preparing a profile, a user may click on the “linux” tag 320 to indicate that he or she has professional experience and/or interest in Linux applications.

The tags 310 may be selected for display on the page 300 based on the frequency with which such tags have been selected by past users creating their own respective employment profiles. In an embodiment, tags most often selected for profiles may be visually distinguished from other tags. For example, more popular tags (i.e., tags having the highest frequency of past selection) may have a larger font size or differently colored text.

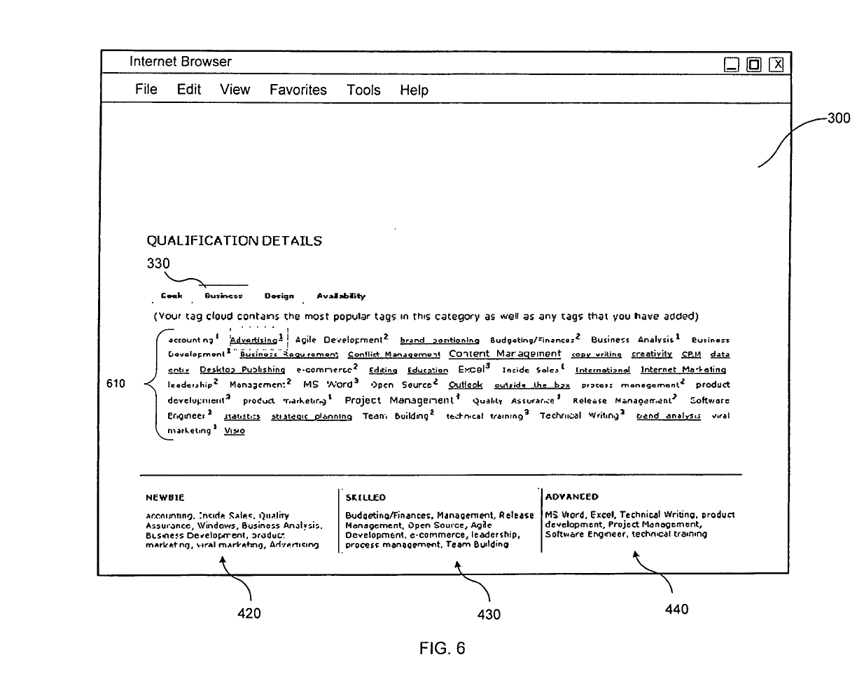

Tag sets may be categorized according to general or specific topics. Each tag-set category may be represented on the page by a selectable tab 330. By selecting a particular tab 330, the user may invoke a tag set topically corresponding to the associated category. The illustrated embodiment includes a “Geek” category tab 330A, “Business” category tab 330B, “Design” category tab 330C, and “Availability” category tab 330D. As can be seen in FIG. 6, by selecting the Business tab 330B, for example, a corresponding set of tags 610 topically corresponding to business- and finance-type skills may be invoked.

If the user wishes to add a tag that is not included in the tag set 310, the user can enter the name of the tag term into a data entry field 340. In an embodiment, once the user begins entering a tag term the page 300 automatically suggests completions consisting of alphanumerically similar tags that the user may select to prevent the accumulation of duplicate tags. Otherwise, once the user has entered the term into the field 340 and selected a submit button 350, the entered term is, at least temporarily, added to and displayed in the tag set 310. Once the term is entered by a predetermined number of users (i.e., becomes sufficiently popular), the term may be permanently added to the tag set 310, such that all users who access the web page 300 may view and select the tagged term.

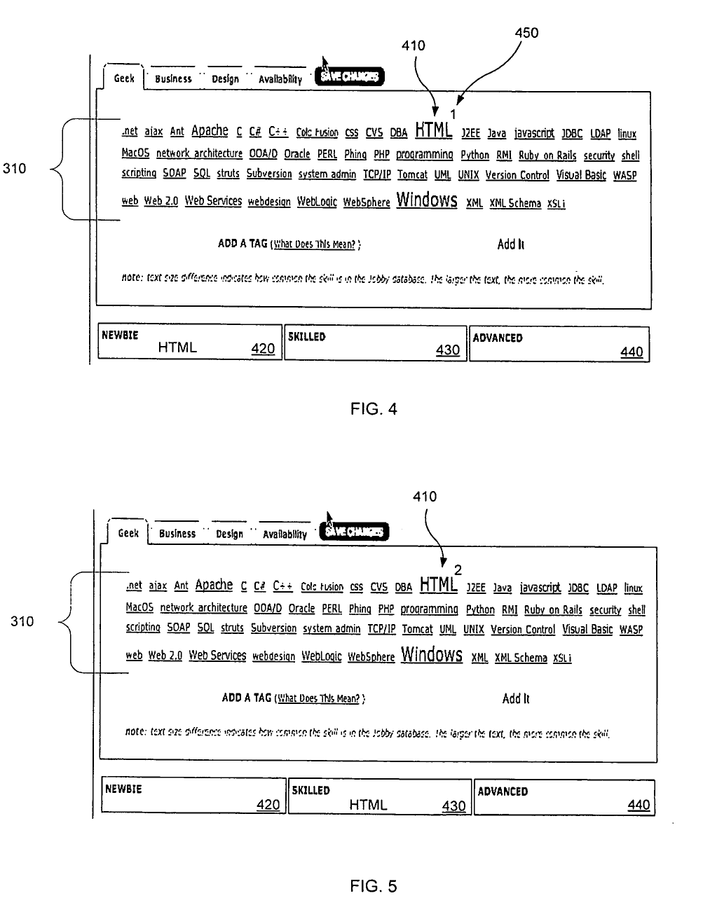

Referring now to FIG. 4, the user can indicate different levels of proficiency and/or experience with regard to a particular characteristic by, for example, selecting a corresponding tag multiple times. In the illustrated example, the user clicks on the “HTML” tag 410 once to add that tag to a “Newbie” portion 420 of the user's profile to indicate that the user has the lowest level of experience in connection with the HTML characteristic. The tag 410, itself, may also be marked by an indicator 450, such as a numeral, to indicate proficiency.

As illustrated in FIG. 5, clicking on the tag 410 a second time adds the tag to the “Skilled” portion 430 of the user's profile to indicate that the user is skilled in the HTML characteristic. Clicking on the tag 410 a third time would add the tag to the “Advanced” portion 440 of the user's profile to indicate that the user has advanced skills in the HTML characteristic.

The process described with reference to FIGS. 3-5 may be repeated with other tags so as to accumulate a set of specific characterizations of the user's skill levels in the tasks or other attributes that may be associated with displayed tags. FIG. 6 illustrates an example of a completed profile that a user can create by selecting various tags.

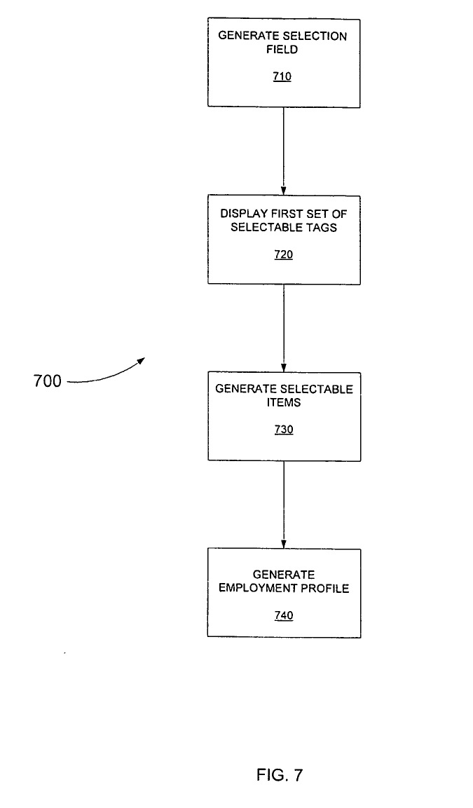

FIG. 7 illustrates a process 700 according to an embodiment of the invention. The process 700 is implementable in an electronic system coupled to an electronic device, the electronic device being coupled to a display device. The process 700 is illustrated as a set of operations shown as discrete blocks. The process 700 may be implemented in any suitable hardware, software, firmware, or combination thereof. The order in which the operations are described is not to be necessarily construed as a limitation.

At a block 710, a selection field is generated in a user interface. For example, the web page 300 provides a graphical user interface including a selection field 305 that allows a user to input object selections and/or data from which an employment profile may be prepared.

At a block 720, a first set of selectable tags is displayed in the selection field. Each of the first-set tags corresponds to a respective vocational characteristic of a first set of vocational characteristics. For example, the displayed web page 300 includes a set of selectable tags 310 in the selection field 305. Each of the tags 310 is descriptive of a vocational characteristic that may be used to at least partially describe a user.

At a block 730, first and second selectable items respectively associated with first and second categories are generated in the user interface. Selection of a category item causes a corresponding tag set to be displayed in the selection field. For example, as discussed above with reference to FIG. 3, tag sets may be categorized according to general or specific topics. Each tag-set category may be represented on the page by a selectable tab 330. By selecting a particular tab 330, the user may invoke a tag set topically corresponding to the associated category.

At a block 740, an employment profile of a user is generated using at least one tag selected by the user. FIG. 6 illustrates an example of a completed profile that a user can create by selecting various tags.

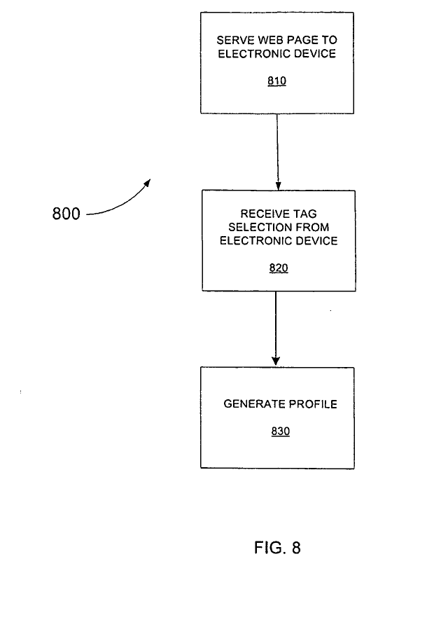

FIG. 8 illustrates a process 800 according to an embodiment of the invention. The process 800 is implementable in an electronic system coupled to an electronic device, the electronic device being coupled to a display device. The process 800 is illustrated as a set of operations shown as discrete blocks. The process 800 may be implemented in any suitable hardware, software, firmware, or combination thereof. The order in which the operations are described is not to be necessarily construed as a limitation.

At a block 810, a web page displayable on a display device is served to an electronic device. The displayed web page includes a user interface comprising a selection field. A first set of selectable tags is displayed in the selection field. Each of the first-set tags corresponds to a respective vocational characteristic of a first set of vocational characteristics. In an embodiment, the web page is served to the electronic device through a network. For example, by employing an appropriate URL, a user may request from the server 230 the web page 300 to be displayed on the display device 250. The web page 300 provides a graphical user interface including a selection field 305 that allows the user to input object selections and/or data from which an employment profile may be prepared. In an embodiment, the displayed web page 300 includes a set of selectable tags 310 in the selection field 305. Each of the tags 310 is descriptive of a vocational characteristic that may be used to at least partially describe a user.

At a block 820, at least one user selection of a tag is received. For example, each of the tags 310 may be displayed on the page 300 as an object that may be selected by a user via, for example, a conventional point-and-click device, such as a mouse.

At a block 830, an employment profile of the user using the at least one tag selection is generated. FIG. 6 illustrates an example of a completed profile that a user can create by selecting various tags.

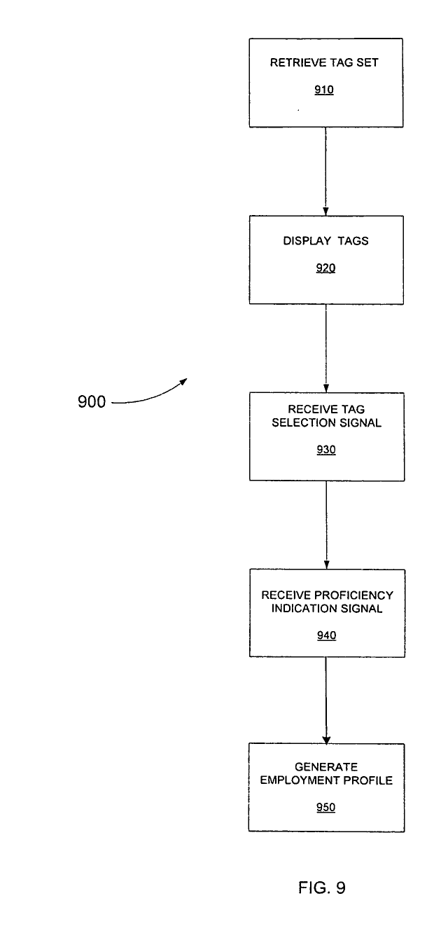

FIG. 9 illustrates a process 900 according to an embodiment of the invention. The process 900 is implementable in an electronic system coupled to an electronic device, the electronic device being coupled to a display device. The process 900 is illustrated as a set of operations shown as discrete blocks. The process 900 may be implemented in any suitable hardware, software, firmware, or combination thereof. The order in which the operations are described is not to be necessarily construed as a limitation.

At a block 910, a first set of selectable tags is retrieved. Each of the first set tags correspond to a respective vocational characteristic of a first set of vocational characteristics. For example, the tag set may be retrieved from the database 240.

At a block 920, the first-set tags are displayed on the display.

At a block 930, a tag selection signal, indicative of a user interface selection device selecting a tag of the first set, is received. For example, each of the tags 310 may be displayed on the page 300 as an object that may be selected by a user via, for example, a conventional point-and-click device, such as a mouse.

At a block 940, a proficiency indication signal, indicative of a proficiency level of the user with respect to a first characteristic of the first vocational-characteristic set, is received. For example, the user can indicate different levels of proficiency and/or experience with regard to a particular characteristic by, for example, selecting a corresponding tag multiple times.

At a block 950, in response to the selection signal, an employment profile of a user is generated using the selected tag.

While a preferred embodiment of the invention has been illustrated and described, as noted above, many changes can be made without departing from the spirit and scope of the invention. Instead, the invention should be determined entirely by reference to the claims that follow.

1. A computer-readable medium having computer-executable instructions for performing steps comprising:
generating in a user interface a selection field;
displaying in the selection field a first set of selectable tags, each of the first-set tags corresponding to a respective vocational characteristic of a first set of vocational characteristics; and
generating an employment profile of a user using at least one tag selected by the user.

2. The medium of claim 1 having further computer-executable instructions for performing the step of displaying in the selection field a second set of selectable tags, each of the second-set tags corresponding to a respective vocational characteristic of a second set of vocational characteristics.

3. The medium of claim 2 wherein the first and second selectable-tag sets respectively correspond to first and second categories.

4. The medium of claim 3 having further computer-executable instructions for performing the step of generating in the user interface first and second selectable items respectively associated with the first and second categories, wherein selection of a category item causes the corresponding tag set to be displayed in the selection field.

5. The medium of claim 1 wherein the user interface enables the user to indicate a proficiency level of the user with respect to a first characteristic of the first vocational-characteristic set.

6. The medium of claim 5 wherein the user indicates the proficiency level by selecting the tag corresponding to the first characteristic a predetermined number of times.

7. A method implementable in an electronic system coupled to an electronic device, the electronic device being coupled to a display device, the method comprising:
serving to the electronic device a web page displayable on the display device, the displayed web page including a user interface comprising a selection field, wherein a first set of selectable tags is displayed in the selection field, each of the first-set tags corresponding to a respective vocational characteristic of a first set of vocational characteristics;
receiving at least one user selection of a tag; and
generating an employment profile of the user using the at least one tag selection.

8. The method of claim 7 wherein a second set of selectable tags is displayed in the selection field, each of the second-set tags corresponding to a respective vocational characteristic of a second set of vocational characteristics.

9. The method of claim 8 wherein the first and second selectable-tag sets respectively correspond to first and second categories.

10. The method of claim 9 wherein:
first and second selectable items respectively associated with the first and second categories are displayed in the selection field; and
selection of a category item causes the corresponding tag set to be displayed in the selection field.

11. The method of claim 7 wherein the user interface enables the user to indicate a proficiency level of the user with respect to a first characteristic of the first vocational-characteristic set.

12. The method of claim 11 wherein the user indicates the proficiency level by selecting the tag corresponding to the first characteristic a predetermined number of times.

13. The method of claim 7 wherein the user interface includes a data-entry field, and further comprising receiving from the electronic device a vocational characteristic manually entered by the user into the data-entry field.

14. The method of claim 13, further comprising predetermined displaying in the selection field a tag corresponding to the manually entered vocational characteristic upon receiving the manually entered vocational characteristic a predetermined number of times.

15. The method of claim 13, further comprising, upon the user entering in the data-entry field at least a portion of the manually entered vocational characteristic, generating in the user interface at least one suggested vocational characteristic alphanumerically similar to the manually entered vocational characteristic.

16. The method of claim 15 wherein the suggested vocational characteristic corresponds to a tag displayed in the selection field.

17. In a computer system having a graphical user interface including a display and a user interface selection device, a method comprising the steps of:
retrieving a first set of selectable tags, each of the first-set tags corresponding to a respective vocational characteristic of a first set of vocational characteristics;
displaying the first-set tags on the display; and
receiving a tag selection signal indicative of the user interface selection device selecting a tag of the first set, and, in response to the selection signal, generating an employment profile of a user using the selected tag.

18. The method of claim 17 further comprising receiving a proficiency indication signal indicative of a proficiency level of the user with respect to a first characteristic of the first vocational-characteristic set.

19. The method of claim 18 wherein the proficiency indication signal is indicative of the user interface selection device selecting the tag corresponding to the first characteristic a predetermined number of times.
